(19) United States
(12) Patent Application Publication
(10) Pub. No.: US 2011/0176534 A1
(43) Pub. Date: Jul. 21, 2011

(54) COMMUNICATION DEVICE AND METHOD FOR SYNCHRONISATION

(75) Inventors: Ananth Subramanian, Singapore (SG); Xiaoming Peng, Singapore (SG); Po Shin Francois Chin, Singapore (SG)

(73) Assignee: AGENCY FOR SCIENCE, TECHNOLOGY AND RESEARCH, Singapore, SG (SG)

(21) Appl. No.: 12/739,350

(22) PCT Filed: Oct. 21, 2008
(86) PCT No.: PCT/SG08/00408

§ 371 Date: Sep. 22, 2010

Related U.S. Application Data
(60) Provisional application No. 60/981,878, filed on Oct. 23, 2007.

(51) Int. Cl. H04W 56/00; H04W 24/04

(52) U.S. Cl. 370/350; 370/345

(57) ABSTRACT

A communication device is provided, the communication device comprising a receiving circuit configured to receive a message from another communication device; a time base circuit providing a time base signal that specifies a plurality of time periods; a determining circuit configured to determine, based on an expected reception time of the message and a reception time of the message, a parameter value characterizing a time base offset between the communication device and the other communication device; an offset generating circuit configured to generate a time period offset value specifying a time offset from a point in time, the time period offset value corresponding to a number of time periods from the plurality of time periods, wherein the number of time periods is determined according to the parameter value.

The present application claims the benefit of the U.S. provisional application 60/981,878 (filed on 23 Oct. 2007), the entire contents of which are incorporated herein by reference for all purposes.

### TECHNICAL FIELD

Embodiments relate to the field of communication systems, such as ad-hoc radio communication devices' groups, for example. By way of example, embodiments relate to a method of synchronization among the communication devices within ad-hoc communication devices' groups.

### BACKGROUND

A communication system generally consists of a plurality of communication devices, wherein the communication among the communication devices are either central-controlled or self-organized.

An ad-hoc radio communication group generally consists of a plurality of ad-hoc radio communication devices, wherein the communication among these devices is self-organized. The plurality of devices are able to discover each other within a range to form the communication group, and within the communication group, they can communicate with each other without the need of a central control.

Many services running on communication systems require accurate synchronization among devices for correct operation and coordination of events.

Several of standards have been put forward to define approaches for synchronization among communication devices within a communication system, among which the ECMA standard is one such. The ECMA standard provides protocols for ad-hoc radio communication devices' group and specifications for high data rate Wireless Personal Area Networks (WPANs). Embodiments described in the following are mainly based on the ECMA standard. However, it is to be noted that various changes in form and detail may be made therein without departing from the scope of the invention as defined by the appended claims.

In the current version of the ECMA standard, the maximum clock drift allowed between any two devices is 40 parts/million (ppm). With this permissible clock drift between two devices, the end of one device's superframe can be slower or faster than the end of another communication device's superframe by up to even 2.6 microseconds. The above drift has implications on applications such as ranging which require the clocks to be synchronized to clock periods level (in order to get better ranging accuracy). As background information, clock drift for example refers to several related phenomena where a clock does not run at the exact right speed compared to another clock. That is, after some time the clock “drifts apart” from the other clock.

In one embodiment, clock periods level synchronization is achieved between communication devices within a communication system. It is noted that if clock periods level synchronization can be achieved, then an added advantage is that even OFDM symbol transmissions can be synchronized between devices allowing for slotted offset Time Frequency Codes (TFCs) (cf. [3]). In one embodiment, ranging is performed by ECMA devices by altering the functionality of the Range Measurement command frame (cf. [1]).

A second synchronization issue that may arise between ECMA devices is the synchronization of notches, cf. [4] (see also supporting material [5]), pertaining to detection of interference, where all the devices synchronously notch a few tones during their transmissions every few superframes.

In [4], it is proposed that all devices synchronously sweep notches (of a fixed number of tones) every few superframes so as to detect an interferer. In one embodiment, notch synchronization between devices is achieved.

In one embodiment, a solution to one or both of the following two synchronization issues related to high-speed ultra wideband (UWB) wireless connectivity, in particular, ECMA UWB connectivity, is provided: The first synchronization issue is pertaining to clock drift between devices, and the second synchronization issue is related to notch synchronization between ECMA devices (for the purpose of detection and avoidance of interferences). Technical challenges are addressed at both the MAC layer and the PHY layer that will enable ECMA devices to resolve the above synchronization issues.

### SUMMARY

In one embodiment, a communication device is provided, the communication device comprising a receiving circuit configured to receive a message from another communication device; a time base circuit providing a time base signal that specifies a plurality of time periods; a determining circuit configured to determine, based on an expected reception time of the message and a reception time of the message, a parameter value characterizing a time base offset between the communication device and the other communication device; an offset generating circuit configured to generate a time period offset value specifying a time offset from a point in time, the time period offset value corresponding to a number of time periods from the plurality of time periods, wherein the number of time periods is determined according to the parameter value.

In one embodiment, an ad-hoc communication device is provided, the ad-hoc communication device comprising a sending circuit configured to transmit data; a memory configured to store a parameter specifying, a time interval and at least one frequency range, wherein the frequency range may not be used for transmitting data during the time interval; a control circuit configured to control the sending circuit such that the frequency range is not used for transmitting data during the time interval; a message generating unit configured to generate a message including a specification for the time interval and for the at least one frequency range, wherein the frequency range may not be used for transmitting data during the time interval; and a transmitting circuit configured to transmit the message.

### BRIEF DESCRIPTION OF THE DRAWINGS

The drawings are not necessarily to scale, emphasis instead generally being placed upon illustrating the principles of various embodiments. In the following description, various embodiments are described with reference to the following drawings, in which:

FIG. 1 shows an illustration of the structure of a superframe;

FIG. 2 shows communications among communication devices within a communication devices' group;

FIG. 3 shows an illustration of the superframe alignment with Beacon Period Start Times (BPSTs) of communication devices;

FIG. 4 shows a communication device according to an embodiment of the invention;

FIG. 5 shows an illustration of synchronization according to one embodiment of the invention;

FIG. 6 shows a flow diagram of the synchronization method according to one embodiment of the invention;

FIG. 7 shows a communication device according to an embodiment of the invention;

FIG. 8 shows the format of the proposed Notch Synchronization Information Element (IE) according to an embodiment of the invention;

FIG. 9 shows an ad-hoc communication device according to an embodiment of the invention; and

FIG. 10 shows an ad-hoc communication device according to an embodiment of the invention.

### DESCRIPTION

As background information, according to the ECMA standard, a superframe is defined as periodic time interval used to coordinate frame transmissions between devices, each superframe comprising 256 Medium Access Slots (MASs) of 256 μs each. A frame may be defined as unit of data transmitted by a device. The superframe is a periodically repeating structure to which the devices in a group synchronize. A superframe includes a Beacon Period (BP) followed by a data period. A BP comprises a number of beacon slots, and a beacon can be transmitted within a beacon slot. Beacon Period (BP) may be defined as a period of time declared by a device during which it sends or listens for beacons, and the term beacon may refer to information regarding such as the reservation of time slots in the further data period. Data period is used to transmit data among devices.

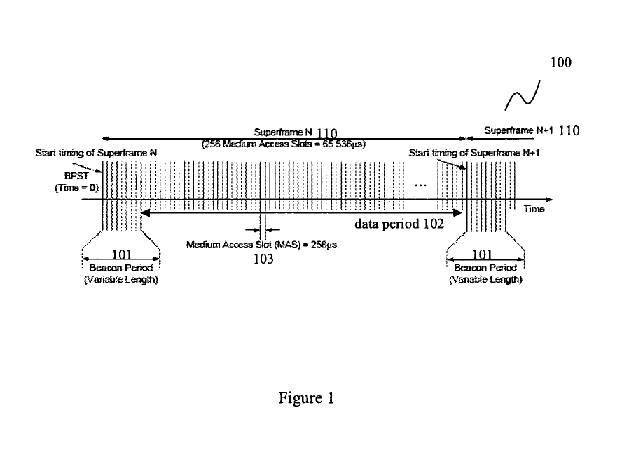

The structure of a superframe is illustrated in FIG. 1. A superframe 110 contains a beacon period 101 followed by a data period 102. A superframe is composed of 256 MASs 103.

Each superframe 110 starts with a BP 101, which extends over one or more contiguous Medium Access Slots (MASs) 103. The start of the first MAS in the BP, and the superframe, is called the Beacon Period Start Time (BPST).

Beacons may carry a variety of network management information in beacon parameters and Information Elements (IEs). Beacon parameters include the device's unique address and beacon slot in which the beacon was transmitted. For each device within an ad-hoc communication devices' group, the device generally has a fixed beacon slot number wherein the beacon is sent within the beacon period. In case there is increased or decreased number of devices within the ad-hoc communication devices' group, the beacon slot number of the communication device may vary correspondingly.

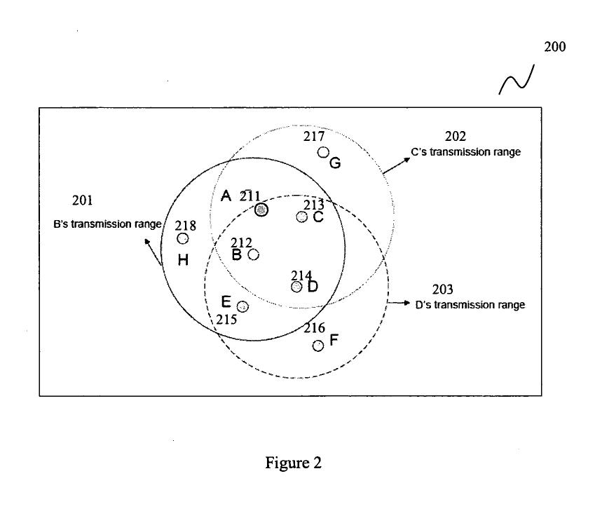

FIG. 2 shows an illustration of a communication system 200 including communication devices A to H (211-218). In one embodiment, the communication system may be an ad-hoc communication group (beacon group) 200 including ad-hoc communication devices A to H (211-218), wherein all the devices A to H (211-218) work in a particular frequency channel. The term frequency channel may refer to a combination of one or more frequency bands, and such a combination may be used for signal transmission. The term frequency band may refer to a predefined continuous frequency range, which may be used for signal transmission. For illustration, circle line 201 represents the transmission range of device B 212, meaning that device B is able to transmit data to other communication devices that are located within the circle line 201. In this illustration, device B 212 is able to transmit data to devices A 211, C 213, D 214, E 215, and H 218. Similarly, circle line 202 represents the transmission range of device C 213, meaning that device C is able to transmit data to other communication devices that are located within the circle line 202, and circle line 203 represents the transmission range of device D 214, meaning that device D is able to transmit data to other communication devices that are located within the circle line 203. During the BP, each device of the beacon group selects a different beacon slot, and the beacon slot occupancy is maintained in as compact a form as possible, growing and shrinking as the number of devices within range varies.

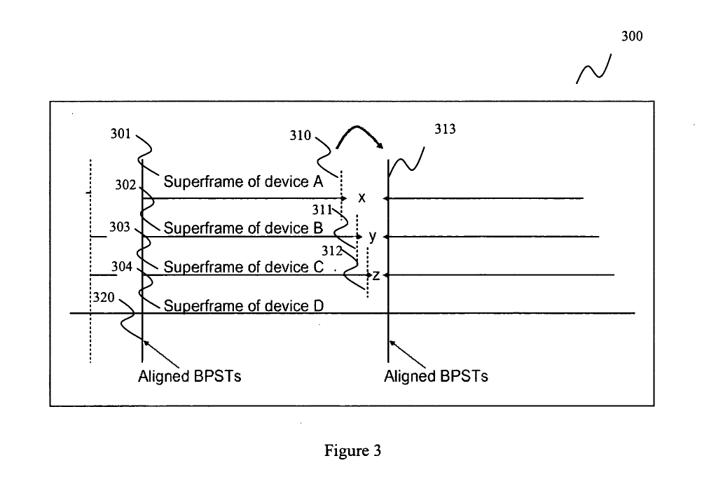

FIG. 3 illustrates the mechanism of synchronization among communication devices by superframe alignment with BPSTs aligned to the slowest device.

According to the current version of the ECMA standard, every device in a beacon group is allowed to synchronize its Beacon Period Start Time (BPST) to the slowest neighbor. Every device is able to calculate the clock drift between itself and every neighbor it receives beacons from, by knowing how much its BPST is lagging or leading its neighbor's BPST. When a device receives a beacon from a neighbor, the device determines the difference between the beacon's actual reception time and the expected reception time. The beacon's actual reception time is the time that the start of the beacon preamble arrived at the receiving device's antenna. The expected reception time is determined from the Beacon Slot Number field of the received beacon and the receiving device's BPST. If the difference is positive, then the neighbor is slower.

In one embodiment, every communication device maintains a virtual clock (for example a register) to maintain synchronization between devices to clock periods level. Refer to FIG. 3. Consider the example in FIG. 3 with four devices with device A 211 having the fastest clock and device D 214 having the slowest clock. Assume that the four devices A 211-D 214 share a same BPST 320 in their respective superframes 301, 302, 303, and 304. The length of the superframes 301-304 are different due to the clock drift among the devices A 211-D 214. As illustrated in FIG. 3, the superframe 301 of device A 211 ends at the time point 310; the superframe 302 of device B 212 ends at the time point 311; the superframe 303 of device C 213 ends at the time point 312; and the superframe 304 of device D 214 ends at the time point 313. In the current version of the ECMA, the device A 211 is able to measure the time difference between time points 313 and 310, namely the variable x in nano seconds (see FIG. 3) using the procedure mentioned above. Hence if device A 211 defers its next BPST by x ns, namely starting its next superframe x ns later than the time point 310, the BPSTs of A 211 and D 214 would be aligned. If devices B 212 and C 213 also follow a similar procedure, then all the devices will be synchronized to the slowest neighbor every superframe.

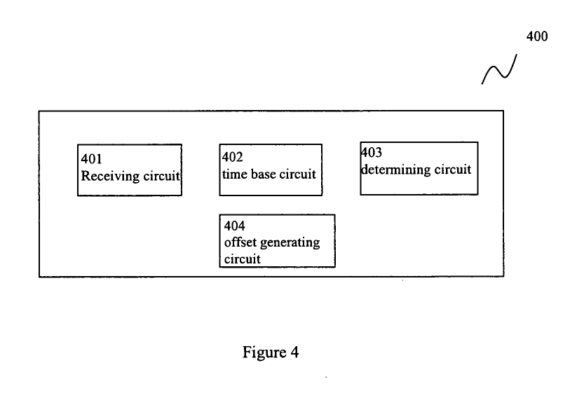

FIG. 4 shows a communication device 400 according to an embodiment.

The communication device 400 may comprise a receiving circuit 401, a time base circuit 402, a determining circuit 403, and an offset circuit 404.

In an embodiment, the receiving circuit 401 is configured to receive a message from another communication device. As an illustration, the communication device A 211 in FIG. 3 may comprise a receiving circuit 401 to receive a message from another communication device D 214. In one embodiment, such a message may be a beacon that device A 211 receives from device D 214 periodically, i.e. every superframe. In an embodiment, the message contains information indicating the presence of the other communication device D 214.

In an embodiment, the communication device 400 is an ad-hoc communication device. For example, the communication device A 211 is an ad-hoc communication device. In an embodiment, device D 214 that device A 211 receives the message from is an ad-hoc communication device.

In an embodiment, the time base circuit 402 provides a time base signal that specifies a plurality of time periods. In an embodiment, the time base signal is a periodic time base signal. In an embodiment, the time base signal is a clock signal. In one embodiment, the clock signal is provided by a physical quartz crystal. In one embodiment, the time base signal provided by the time base circuit 402 is a physical clock signal. In an embodiment, the time periods are regular time periods. In an embodiment, the time periods are clock cycles.

In one embodiment, the communication device receives from the other communication device a periodic message being transmitted with reference to a transmission time point determined based on a time base signal of the other communication device. In one embodiment, the time point is the Beacon Period Start Time (BPST) of the other communication device or the Beacon Period Start Time of the communication device. As an illustration, the periodic message may be a beacon sent by the other communication device. Normally, within a communication group, each communication device sends its beacon at a fixed beacon slot within each superframe based on its time base signal. Accordingly, the communication device will receive a beacon from the other communication device at a fixed time relative to a time point, i.e. BPST of each superframe determined based on a time base signal of the other communication device.

In one embodiment, the periodicity of the periodic message the communication device receives does not change for a fixed time period.

In one embodiment, the periodic message is a beacon. In one embodiment, the periodicity is superframe duration of the other communication device in accordance with the time base signal of the other communication device. The periodicity may be also referred to period length or a superframe. In one embodiment, the fixed time period is two superframes duration in accordance with the time base signal of the other communication device.

In an embodiment, the determining circuit 403 is configured to determine, based on an expected reception time of the message and a reception time of the message, a parameter value characterizing a time base offset between the communication device and the other communication device. In an embodiment, the determining circuit 403 may determine the time difference between clock period of device A 211 and the clock period of another communication device D 214 based on the expected reception time of the beacon from device D 214 and a reception time of the beacon from device D 214. In one embodiment, the determining circuit 403 may use a parameter to characterize such a time difference.

In one embodiment, the parameter value characterizes a difference between the time base signal and a time base signal of the other communication device. As an illustration, the parameter value characterizes a difference between the time base signal of device A 211 and the time base signal of device D 214. In one embodiment, such a difference may be caused due to clock drift.

In one embodiment, the time base signal is a physical clock signal.

In an embodiment, the offset generating circuit 404 is configured to generate a time period offset value specifying a time offset from a point in time, the time period offset value corresponding to a number of time periods from the plurality of time periods, wherein the number of time periods is determined according to the parameter value.

In one embodiment, the offset generating circuit 404 generates a virtual clock, and the virtual clock synchronizes with the physical clock of the slowest communication device within the communication devices' group. In one embodiment, the beacon transmission is based on a virtual clock. The use of virtual clocks is proposed to achieve clock periods level synchronization throughout the superframe in addition to the above end of superframe (≈65 ms) level synchronization. In one embodiment, the proposed virtual clock (could be a register) of every device is synchronized to the physical clock (crystal) of the slowest device and every device receives its timing from its virtual clock that it maintains. In the following, a strategy by which devices can maintain synchronized virtual clocks will be given in detail.

In one embodiment, a communication device determines, based on a message received from another communication device, an offset, e.g. a difference, between the time base signal of the communication device and the time base signal of another communication device. Based on this offset, the communication device may determine a time period offset, for example the time for the execution of certain event, for example in the form of a number of time periods, such as clock cycles. The number of time periods of the time period offset is for example selected based on the time base offset between the communication devices such that the execution of an event based on the time period offset, for example, results in synchronization between the communication devices.

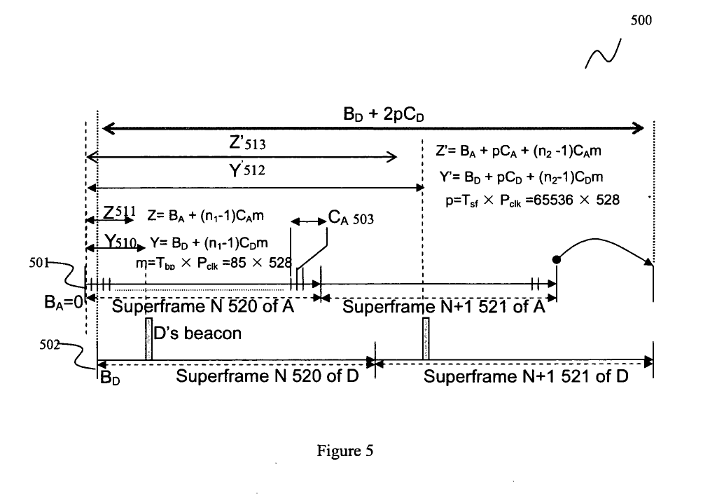

As an illustration of the embodiments, assume that devices A 211 and D 214 (as shown in FIG. 3) have entered or joined a same beacon group. Let P_{clk} be the physical (hardware) clock (current ECMA PHY clock is 528 MHz). As shown in FIG. 5, let B_{A} 501 be the BPST of device A 211, B_{D} 502 be the BPST of device D 214 from A 211's perspective, C_{A} 503 be the clock period of A 211 (Assume A 211's clock period to be l/P_{clk}; assume A 211's clock to be of 528 MHz, and hence A 211's clock period is 1/528 microseconds), and C_{D} be the clock period of D 214 from A 211's perspective. Let the beacon slot of D 214 as seen by A 211 ben₁, a known quantity. Let m=T_{bp}×P_{clk} be the number of clock cycles for a beacon slot duration, where T_{bp} is the time duration of each beacon slot. For current ECMA specified devices, T_{bp}=85 μs and P_{clk}=528 MHz. Hence m=85×528. In every beacon slot as seen by a device, the same device's physical clock counts m cycles. Let Y 510 be the actual reception time of the beacon of D 214 at A 211 (discounting propagation time), Z 511 be the estimated reception time of D 214's beacon at A 211.

Assume that no device moves its BPST at the end of the current (first) superframe (superframe N 520). In the next superframe (superframe N+1 521), the devices A 211 and D 214 do not move their BPSTs. Let Y′512 and Z′ 513 be respectively the actual and estimated reception times of D 214's beacon at A 211 in superframe N+1 521. Let n₂ be the Beacon Slot Number of beacon of D 214 in superframe N+1 521. Let p=T_{sf}×P_{clk} be the number of clock cycles for a superframe duration, where is the time duration of one superframe. For current ECMA specified devices, T_{sf}=65536 μs, hence p=65536×528. In every superframe, the same device's physical clock counts p cycles. Note that P_{clk} can be selected differently depending on individual implementations. For example, P_{clk} may also be selected based on 66 MHz clock. In such a case, A 211's clock period is 1/66 microseconds, and m=85×66 and p=65536×66. In one embodiment, % may be selected to be based on the frequency F of the physical clock crystal used by the device A 211. Accordingly, the clock period of device A 211 is 1/F seconds.

Now, Y 510, Z 511, Y′ 512, and Z′ 513 are known at device A 211 with respect to a fixed reference time (could be the BPST of A 211, B_{A} 501). From the following four relations,

Z=B_{A}+(n₁−1)C_{A}m (1)

Y=B_{D}+(n₁−1)C_{D}m (2)

Z′=B_{A}+pC_{A}+(n₂−1)C_{A}m (3)

Y′=B_{D}+pC_{D}+(n₂−1)C_{D}m (4)

where m=T_{bp}×85×528, p=T_{sf}×P_{clk}=65536×528
the estimates of B_{D} and C_{D} in two superframes can be obtained:

C_{D}=(Y′−Y)/(p+m(n₂−n₁)) (5)

B_{D}=Y−(n₁−1)C_{D}m=Y−(n₁−1)(Y′−Y)m/(p+m(n₂−n₁)) (6)

In the third superframe, the device A 211 may align its BPST to device D 214's BPST (which it knows through the knowledge of B_{D}+2pC_{D} and the fixed reference time) and reset its virtual clock count to zero. Let P_{A} be the number of physical clock cycles of A 211 during the superframe duration of D 214 (known to A 211), and P_{D} be the number of physical clock cycles of D 214 in that same superframe duration of D 214. It can be seen that P_{D}=p=65536×528. In one embodiment, (P_{A}−P_{D}) may be referred as a parameter value determined by the determining circuit 403 of device A 211, the parameter value characterizing a time base offset between the communication device A 211 and the other communication device D 214. However, it should be noted that the parameter value is not limited to (P_{A}−P_{D}). In one embodiment, the parameter value characterizes a difference between the time base signal of device A 211 and the time base signal of the other communication device D 214. In one embodiment, the parameter value characterizes a difference between the number of physical clock cycles of device A 211 and the number of physical clock cycles of device D 214 in a same period.

If the device A 211 maintains a count of virtual clock cycles from the third superframe in such a way that its count of virtual clock cycles is obtained from the count of its physical clock cycles by subtracting one clock cycle from the count of its physical clock cycles every floor [P_{A}/(P_{A}−P_{D})] or Round [P_{A}/(P_{A}−P_{D})] of its physical clock cycles, the virtual clock of A 211 will be synchronized to the physical clock of D 214 to one clock period level. In one embodiment, the clock cycles counted by the virtual clock may be referred as the time period offset value generated by the offset generating circuit 404 of the device A 211. In one embodiment, the virtual clock may specify a time offset between the virtual clock and the physical clock. The clock cycles counted by the virtual clock may correspond to or have a relation to the number of clock cycles counted by the physical clock. For example, the virtual clock may skip one clock cycle every floor [P_{A}/(P_{A}−Pₚ)] or Round [P_{A}/(P_{A}−P_{D})] physical clock cycles.

In the above, the function floor [x] denotes the largest integer value not greater than the value ‘x’, and Round [x] denotes the nearest integer value to ‘x’.

If P_{A}−P_{D}=0, then the virtual clock is set to be the same as the physical clock. As seen above, only the first two superframes are needed for estimating clock periods and establishing the virtual clocks.

Two examples are given to illustrate the above proposed schemes.

### Example 1

Given n₁=n₂=n=5 and P_{clk}=528 MHz, C_{A}= 1/528 μs, Y is measured as 342.595 μs and Y′ is measured as 65882.595 μs, then using equation (5), C_{D} can be estimated as 1.89405 ns and using equation (6), B_{D} can be estimated as 2.5752 μs. In the superframe duration of D 214 (=pC_{D}), A 211's clock counts, pC_{D}/C_{A}˜34605028 cycles. However, D 214's clock still counts p=65536×528=34603008 cycles. A 211's virtual clock is got from subtracting 1 clock cycle from every 17131 (which is =34605028/(34605028−34603008)) physical clock cycles of A 211.

### Example 2

Given n₁=n₂=n=5 and P_{clk}=66 MHz, C_{A}= 1/66 μs, Y is measured as 342.595 μs and Y′ is measured as 65882.595 μs, then using equation (5), C_{D} can be estimated as 15.152 ns and using equation (6), B_{D} can be estimated as 2.584 μs. In the superframe duration of D 114(=pC_{D}), A 211's clock counts, pC_{D}/C_{A}˜4325514 cycles. However, D 214's clock still counts p=65536×66=4325376 cycles. A 211's virtual clock is got from subtracting 1 clock cycle from every 31344 (which is ˜4325514/(4325514−4325376)) physical clock cycles of A.

In one embodiment, the communication device estimates the clock period or the time base signal of the other communication device with reference to the time base signal or the clock period of the communication device during the fixed time period. For example, as illustrated above, device A 211 estimates the clock period C_{D} of another communication device D 214 with reference to the clock period of device A 211 during a fixed time period, i.e. two superframes.

In one embodiment, the communication device assumes its clock period to be 1/528 microseconds, or 1/66 microseconds, or 1/F seconds, wherein F is the frequency of the physical clock crystal used by the communication device.

In one embodiment, the communication device determines the Beacon Period Start Time (BPST) of the other communication device in the fixed time period. For example, as illustrated above, device A 211 determines the BPST B_{D} of the other communication device D 214 in the fixed time period of two superframes.

In one embodiment, the communication device determines that the number of clock periods the other communication device counts in accordance with the time base signal of the other communication device during the period length of the periodic message is F times 0.065536 clock cycles wherein F is the frequency of the physical clock crystal used by the device. In this embodiment, 0.065536 comes from the duration of a superframe. For example, let F be 528 MHz, then the number of clock periods a communication device counts in accordance with its physical clock during the duration of a superframe is 65536 μs×528 MHz=0.065536×528×10⁶=0.065536×F.

As an illustration, the communication device determines the number of clock periods given by a physical clock of the communication device in accordance with the time base signal during the period length, i.e. duration of a superframe, of the periodic message, i.e. beacon. The number of clock periods given by the physical clock of the communication device in accordance with the time base signal during the period length, i.e. a superframe duration, of the message, i.e. beacon, may be referred to as ‘P’. The number of clock periods given by the physical clock of the other communication device in accordance with the time base signal of the other communication device during the period length, i.e. duration of a superframe, of the periodic message may be referred to as ‘Q’.

In one embodiment, the communication device, i.e. device A 211, sets up a virtual clock cycle counter which is a register at exactly the end of the fixed time period, i.e. duration of two superframes, and initializes the virtual clock cycle counter to be zero at exactly the end of the fixed time period.

In one embodiment, the device, i.e. device A 211, updates the virtual clock cycle counter after the virtual clock cycle counter is initialized to zero such that the virtual clock cycle counter is obtained from the number of physical clock cycles given by a physical clock since the end of the fixed time period or the end of the previous superframe of the other communication device, i.e., device D 214 by subtracting one clock cycle from the number of physical clock cycles every Floor[P/(P−Q)] or Round[P/(P−Q)] of physical clock cycles if P is greater than Q.

In one embodiment, the communication device sets its virtual clock to be the same as a physical clock of the communication device if P is less than or equal to Q.

In one embodiment, the communication device determines that its physical clock is slower than the physical clock of the other communication device if P is less than or equal to Q.

In one embodiment, the communication device determines that its physical clock is faster than the physical clock of the other communication device if P is greater than Q.

In one embodiment, the communication device resets its virtual clock counter to zero at exactly the end of every superframe of the other communication device in accordance with the time base signal of the other communication device.

In one embodiment, the device determines if it has the slowest physical clock in a communication system comprising the communication device and the neighboring devices of the communication device. In one embodiment, the other communication device has the slowest physical clock in the communication system.

In one embodiment, the time base signal is a periodic time base signal, and the parameter value characterizes the difference of the periodicity of the time base signal and the periodicity of the time base signal of the other communication device. As an illustration, the parameter value characterizes the difference of the periodicity of the time base signal of device A 211 and the periodicity of the time base signal of device D 214, and such a parameter may refer to (P_{A}−P_{D}).

In one embodiment, if the parameter specifies that the time base signal is ahead of the time base signal of the other communication device, the number of time periods for the time offset is determined to be lower than the number of time periods given by the time base signal. As an illustration, if device A 211 decides that the parameter (P_{A}−P_{D})>0, which indicates that device D 214 is slower than device A 211, device A 211 will set a virtual clock by skipping some physical clocks, namely skipping one clock every Floor[P_{A}RP_{A}−P_{D})] or Round[P_{A}RP_{A}−P_{D})] physical clocks in order to synchronize with device D 214. The number of clock cycles counted by the virtual clock of device A 211 is lower than the number of clock cycles counted by the physical clock of device A 211.

In one embodiment, if the parameter specifies that the time base signal is behind the time base signal of the other communication device, the number of time periods for the time offset is determined to be higher than the number of time periods given by the time base signal. As an illustration, if device A 211 decides that the parameter (P_{A}−P_{D})<0, which indicates that device D 214 is faster than device A 211, device A 211 will maintain its virtual clock the same as its physical clock. Device D 214 may determine that device D 214 is faster than device A 211, and device D 214 may set a virtual clock to synchronize with device A 211. It can be seen that the case can be easily extended to an alternative embodiment that if device A 211 determines it is slower than device D 214, device A may set up a virtual clock in such a way that the virtual clock of device A 211 counts one more additional clock cycle every Floor[P_{D}/(P_{D}−P_{A})] or Round[P_{D}/(P_{D}−P_{A})] physical clock cycles in order to synchronize with the faster device D 214. In such a case, there is no need for device D 214 to synchronize with device A 211 but it suffices for device D 214 to set its virtual clock to be the same as its physical clock.

In one embodiment, the time base signals of both the communication device and the other communication device are clock signals, and the parameter characterizes the clock drift between the clock signal and the clock signal of the other communication device. As an illustration, the parameter may be (P_{A}−P_{D}), which characterizes the clock drift between the communication device A 211 and the communication device D 214.

In one embodiment, the receiving circuit 401 is configured to receive a first message and a second message and the determining circuit 403 is configured to determine the parameter value, based on an expected reception time of the first message, and an expected reception time of the second message, a reception time of the first message, and a reception time of the second message. As an illustration, the receiving circuit 401 of device A 211 may receive a first message, i.e. a beacon, in superframe N 520 from device D 214, and receive a second message, i.e. a beacon, in superframe N+1 521 from device D 214. The determining circuit 403 of device A 211 may determine the reception time Y 510 of the first message, the reception time Y′ 512 of the second message. Based on Y 510 and Y′ 512, and also based on the expected reception time of the first message Z 511, and the expected reception time of the second message Z′ 513, the determining circuit 403 may determine the value of B_{D} 502 and C_{D}. From B_{D} 502 and C_{D}, P_{A} may be calculated by pC_{D}/C_{A}. The parameter value, such as (P_{A}−P_{D}), can be determined accordingly.

In one embodiment, the offset generating circuit 404 is configured to set up a virtual clock and count a number of clock cycles having passed since a point in time. As an illustration, the number of clock cycles counted by the virtual clock may skip one clock cycle every Floor [P_{A}/(P_{A}−P_{D})] or Round [P_{A}/(P_{A}−P_{D})] physical clock cycles. In one embodiment, the point in time could for example be the time of the transmission of the last beacon. In one embodiment, the point in time may be BPST. In one embodiment, the point in time may be the start time of a superframe.

In one embodiment, the number of clock cycles is the number of clock cycles that have passed according to the time base signal, increased or decreased according to the parameter value. As an illustration, the number of clock cycles counted by the virtual clock of device A 211 may be less than the clock cycles counted by the physical clock of device A 211, in case the parameter value (P_{A}−P_{D})>0. In an alternative embodiment, it can be seen that the case can be easily extended to that where the number of clock cycles counted by the virtual clock of device A 211 may be more than the clock cycles counted by the physical clock of device A 211, in case the parameter value (P_{A}−P_{D})<0, and the device A 211 with a slower physical clock takes action to synchronize with device D 214.

In one embodiment, the parameter value specifies the periodicity with which a clock cycle among the clock cycles indicated by the time base signal is not counted as clock cycle having passed since the point in time. As an illustration, in case device A 211 determines that it is faster than device D 214, the parameter value, such as (P_{A}−P_{D}), may specify the periodicity, such as Floor[P_{A}/(P_{A}−P_{D})] or Round[P_{A}/(P_{A}−P_{D})], with which a clock cycle among Floor[P_{A}/(P_{A}−P_{D})] or Round[P_{A}/(P_{A}−P_{D})] clock cycles indicated by the physical clock is not counted by the virtual clock. In other words, the virtual clock may skip one clock cycle every Floor[P_{A}/(P_{A}−P_{D})] or Round[P_{A}/(P_{A}−P_{D})] physical clock cycles.

In one embodiment, a method for generating a time indication comprises: receiving a message from another communication device; providing a time base-signal that specifies a plurality of time periods; determining, based on an expected reception time of the message and a reception time of the message, a parameter value characterizing a time base offset between the communication device and the other communication device; generating a time period offset value specifying a time offset from a point in time, the time period offset value corresponding to a number of time periods from the plurality of time periods, wherein the number of time periods is determined according to the parameter value.

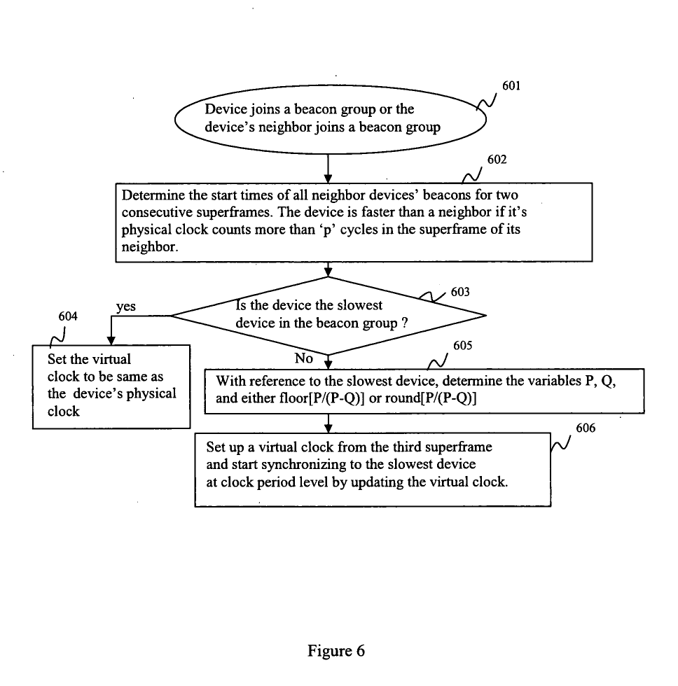

This embodiment is illustrated in the flow diagram shown in FIG. 6.

In reality, it is possible that a device's clock period may change over a period of time due to effects of temperature and other parameters. In one embodiment, every device may optionally spend two superframes every pClockPeriodRefresh superframes to estimate the clock period of the slowest neighbor and subsequently synchronize to the slowest neighbor by means of virtual clock by the procedure given above. In one embodiment, pClockPeriodRefresh may take any value such as 1024 or 8192 or 65536 etc.

An illustration of the synchronization method is given in the flow diagram in FIG. 6.

In FIG. 6, P is the number of physical clock cycles of a device during the duration of a superframe of slowest device, Q (Q=65536×fₒ; where fₒ MHz is the frequency of the clock of slowest device) is the number of physical clock cycles of the slowest device in the same duration of the superframe of slowest device. Firstly in process 601, a device joins a beacon group or the device's neighbor joins a beacon group. Then in process 602, the device determines the start times of all neighbor devices' beacons for two consecutive superframes. The device would be faster than a neighbor if its physical clock counts more than Q (=65536×fₒ) cycles in the superframe of its neighbor. In process 603, the device determines whether it is the slowest device in the beacon group. If the device determines that it is the slowest device in the beacon group, in process 604, the device sets the virtual clock to be same as the device's physical clock. If the device determines that it is not the slowest device in the beacon group, in process 605, the device determines the variables P, Q, and either floor [P/(P−Q)] or round [P/(P−Q)] with reference to the slowest device. Following process 605, in process 606, the device sets up a virtual clock from the third superframe and starts synchronizing to the slowest device at clock period level by updating the virtual clock.

In one embodiment, a computer program product is provided which, when executed by a computer, makes the computer perform a method for generating a time indication comprising: receiving a message from another communication device; providing a time base signal that specifies a plurality of time periods; determining, based on an expected reception time of the message and a reception time of the message, a parameter value characterizing a time base offset between the communication device and the other communication device; generating a time period offset value specifying a time offset from a point in time, the time period offset value corresponding to a number of time periods from the plurality of time periods, wherein the number of time periods is determined according to the parameter value.

In the current version of the ECMA standard, a device is able to start transmitting a beacon anytime within a guard time (mGuardtime, see [1]) from the start of a beacon slot. In one embodiment, the above guard time is made zero for the purpose of beacon transmission and every device sends a beacon at the start of a beacon slot or a known time δ after the start of a beacon slot with an allowance of ± one clock cycle.

In one embodiment, every device maintains a virtual clock synchronized to the slowest physical clock. In one embodiment, the virtual clock count of the slowest device is the same as its physical clock count. Let P be the number of physical clock cycles of a device during the duration of a superframe of slowest device, and Q be the number of physical clock cycles of the slowest device in the same duration of the superframe of slowest device. In one embodiment, a device updates its count of virtual clock cycles in such a way that its count of virtual clock cycles is obtained from the count of its physical clock cycles by subtracting one clock cycle from the count of its physical clock cycles every Floor[P/(P−Q)] or Round[P/(P−Q)] of its physical clock cycles. In this way, the virtual clock of any device will be synchronized to the physical clock of the slowest device to clock period level. If P−Q=0, then the virtual clock of the device is set to be the same as the physical clock of the device. Note that the device calculating P using it's neighbor's beacons can check if it has a faster clock by checking if P−Q>0.

In one embodiment, if the number of physical clock cycles of the device during the duration of a superframe of its neighbor is greater than the number of physical clock cycles of the neighbor in the same duration of the superframe of the neighbor, then the device is faster than the neighbor.

In one embodiment, every device makes its transmission and ranging related decisions based on the virtual clock and not on the physical clock. The virtual clock is reset at the BPST of the slowest device every superframe of the slowest device. In one embodiment, every device receives its timing from its virtual clock that it maintains. In one embodiment, all devices in the beacon group use the first two superframes to estimate the clock periods of the clocks of other communication devices and establish virtual clocks as described above. After the two superframes that are used to set up the virtual clocks, all the virtual clocks are kept synchronized in a distributed manner continuously during every subsequent superframe (synchronized to the physical clock of the slowest device).

The current version of ECMA allows for the exchange of command frames including Range Measurement command frames within a superframe between two ECMA specified devices. However, if there is clock drift between two devices that are exchanging Range Measurement command frames, range measurement may be erroneous.

It is possible that the bits in the range payload field for Range Measurement report frame (see [1]; the bits are transmission and reception times for two way time of arrival based range measurement) that are after the first three most significant octets, may be erroneous if clock drift is present. In one embodiment, these time stamps in the range measurement report type command frame are based on virtual clock and not on physical clock. Since the virtual clocks of all devices can be synchronized using the above procedure, ranging errors can be minimized. Let T_{1,c} be the transmission time of the first Range Measurement command frame from device 1 to device 2. Let device 2 receive the same at time R_{2,c}. Let device 2 transmit a reply Range Measurement command frame at T_{2,c} and device 1 receive the same at R_{1,c}. We then have the estimate of range, R as

R=c×(R_{2,c}−T_{1,c}+R_{1,c}−T_{2,c})/2

where c is the velocity of light. If all the above timing measurements are measured from aligned BPSTs based on virtual clocks, ranging error may be reduced with a 528 MHz clock.

In [3], a scheme to enhance throughput based on slotted offset TFCs is given. The slotted offset TFCs based scheme in [3] requires clock period level synchronization (clock period level clock synchronization can result in MAS level and superframe level synchronization). In one embodiment, every Orthogonal Frequency Division Multiplexing (OFDM) Symbol Transmission Duration abbreviated as OSTD is scheduled based on the virtual clocks, so that OSTDs of devices are synchronized and do not overlap much to cause interference. If all the OSTDs are based on virtual clocks, then all the OSTDs of all the devices will be synchronized or aligned to clock period level.

According to the ECMA standard, in order to support avoidance of other users of the UWB band, the transmitted signal can be sent in the context of Tone Nulling (TN) of any of 128 elements or tones. These elements or tones correspond to the subcarriers of each band within the current band group.

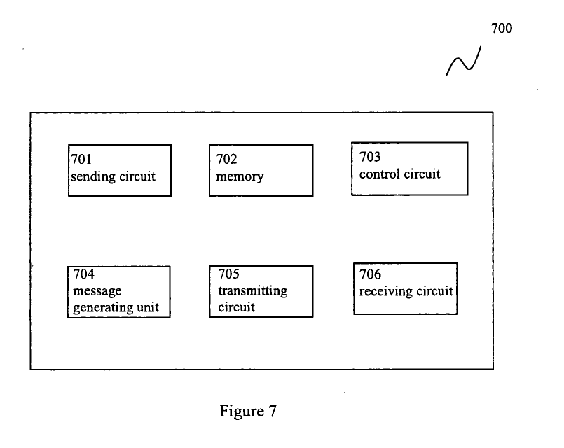

FIG. 7 shows a communication device 700 according to an embodiment.

The communication device 700 may comprise a sending circuit 701, a memory 702, a control circuit 703, a message generating unit 704, and a transmitting circuit 705.

In one embodiment, the sending circuit 701 is configured to transmit data. In one embodiment, the sending circuit 701 is configured to transmit beacons to other communication devices.

In one embodiment, the memory 702 is configured to store a parameter specifying, a time interval and at least one frequency range or a starting frequency of at least one frequency range, wherein the frequency range may not be used for transmitting data during the time interval. As an illustration, the frequency range may correspond to a frequency subcarrier or some frequency subcarriers. The time interval may refer to a superframe or a number of superframes. In one embodiment, the memory 702 is configured to store a parameter specifying range or ranges of subcarriers that may not be used during a superframe or a plurality of superframes.

In one embodiment, the control circuit 703 is configured to control the sending circuit 701 such that the frequency range is not used for transmitting data during the time interval. In one embodiment, the control circuit 703 is configured to control the sending circuit 701 such that the specified subcarriers are nulled during the superframe or the plurality of superframes.

In one embodiment, the message generating unit 704 is configured to generate a message including a specification for the time interval and for the at least one frequency range or the starting frequency of the at least one frequency range, wherein the frequency range may not be used for transmitting data during the time interval. As an illustration, such a message may be a beacon. As a further illustration, such a message may be the Information Element generated by the device. In one embodiment, the message generating unit 704 is configured to generate a message which includes specification for a superframe or a plurality of superframes and for the range or ranges of subcarriers, the range or ranges of the subcarriers are nulled during the superframe or the plurality of superframes.

In one embodiment, the transmitting circuit 705 is configured to transmit the message. In one embodiment, the message is a beacon that is sent to other communication devices. In one embodiment, the message is an Information Element (IE).

In one embodiment, in other words, an ad-hoc communication device stores a parameter specifying, a time interval, i.e. a superframe or a plurality of superframes, and at least one frequency range, i.e. a range of subcarriers or ranges of subcarriers, or the starting frequency of the at least one frequency range, wherein the range or ranges of subcarriers may not be used during the time interval. The ad-hoc communication device transmits data in such a way that the specified at least one frequency range is not used during the specified time interval. The ad-hoc communication device generates a message which contains the specification of the parameter, the parameter specifying that the at least one frequency range, i.e. a range of subcarriers or ranges of subcarriers, may not be used during the time interval, i.e. the superframe or the plurality of superframes. The ad-hoc communication device transmits the message to other communication devices.

In one embodiment, the message is transmitted in another time interval preceding the time interval. In one embodiment, the time interval may refer to superframe N. The message may be sent in a previous superframe N−1. In one embodiment, the message is transmitted in superframe N−1, and the message comprises specification of the range or ranges of subcarriers to be nulled in superframe N or from superframe N onwards.

In one embodiment, the time interval is the next time interval with respect to the other time interval in a sequence of time intervals for transmitting data. As an illustration, the time interval, i.e. superframe N, is next time interval with respect to the other time interval, i.e. superframe N−1, during which the message is sent in a sequence of time intervals for transmitting data. In one embodiment, the specified superframe N during which the specified subcarriers are to be nulled is next to superframe N−1 during which the message is sent, wherein the message comprises specification of the range or ranges of subcarriers not to be used during superframe N.

In one embodiment, the message includes a list of frequency ranges that are not to be used for transmitting data in the time interval. As an example, the message may include a list of frequency subcarriers that are to be nulled for transmitting data in the time interval. In one embodiment, the message comprises a list of ranges of subcarriers to be nulled during the specified superframe or the specified plurality of superframes.

In one embodiment, the parameter and the specification specify that tone nulling should be performed in the time interval in the frequency range. As an illustration, the frequency range may refer to a frequency subcarrier or a plurality of frequency subcarriers. In one embodiment, the parameter and the specification specify that tone nulling should be performed during the specified superframe or the specified plurality of superframes for the specified range or ranges of frequency subcarriers.

In one embodiment, the length of the time interval specified in a message transmitted at a superframe N by the device is one time unit longer than the time interval specified in a message transmitted at a superframe N+1 by the communication device. As an illustration, the time interval specified in a message, i.e. an IE or a beacon, transmitted at superframe N by the device may be say of value 2. The time interval specified in a message, i.e. a beacon or an IE, transmitted at superframe N+1 by the device may be say of value 1. Accordingly, the length of time interval included in a beacon or an IE transmitted at superframe N is one superframe longer than the length of time interval included in a beacon or an IE transmitted at superframe N+1.

In one embodiment, the length of the time interval specified in a message transmitted at a superframe N by the device is one superframe longer than the length of the time interval specified in a message transmitted at a superframe N+1 by the communication device. As an illustration, the time interval specified in a message, i.e. a beacon or an IE, transmitted at superframe N by the device may be superframes N+1, and N+2, and thus is two superframes long. The time interval specified in a message, i.e. a beacon or an IE, transmitted at superframe N+1 by the device may be superframe N+2, and thus one superframe long. Accordingly, the length of time interval included in a beacon or an IE transmitted at superframe N is one superframe longer than the length of time interval included in a beacon or an IE transmitted at superframe N+1.

In one embodiment, the length or duration or value of the time interval specified in the message transmitted in a superframe is reset to a fixed non zero value if the time interval specified in a message transmitted in the superframe preceding the superframe is zero. As an illustration, if the time interval specified in a beacon or an IE from the communication device in superframe N−1 is zero, then the time interval specified in a beacon or an IE from the communication device in superframe N is reset to a fixed non zero value, which may be duration of one superframe or a plurality of superframes. In one embodiment, the message comprises a tone offset which is the first tone or first frequency in a set of tones or frequencies, and wherein the set of tones corresponding to the first tone or the tone offset specified is to be nulled or not to be used during the time interval. In one embodiment, the message is transmitted once every fixed time period. In one embodiment, the fixed time period is a superframe.

In one embodiment, the message comprises the first of a set of tones or frequency ranges to be nulled. In this embodiment, it is assumed that it is understood a priori by all devices how many tones or frequency ranges are nulled. As an illustration, it may be known to all the devices within a communication system several sets of tones or frequency ranges that may be nulled, each set of tones or frequency ranges having a unique starting (first) tone or frequency. Thus, when the message, i.e., the beacon or IE, specifies the first tone or starting frequency of a set of tones or frequency ranges to be nulled, all the other communication devices will know which set of tones or frequency ranges to be nulled.

In one embodiment, the message is transmitted in a superframe and the tone offset is increased by a fixed value from the tone offset specified in a message transmitted in a superframe preceding the superframe if the length of time interval specified in the message transmitted in the superframe preceding the superframe is zero. As an illustration, if the length of the time interval specified in the message, i.e. beacon or IE, transmitted in the superframe N−1 is zero, then in superframe N, the tone offset specified in the beacon or IE in superframe N will be increased by a fixed value from the tone offset specified in the beacon or IE transmitted in superframe N−1. As each set of tones or frequency ranges may have a unique starting tone or frequency, the increased tone offset may correspond to another set of tones or frequencies to be nulled.

In one embodiment, the communication device 700 may further comprise a receiving circuit 706 as shown in FIG. 7. In one embodiment, the receiving circuit 706 is configured to receive a second message indicating that the frequency range may not be used for transmitting data during the time interval. For example, the second message may be sent by another communication device within the same beacon group. In one embodiment, the receiving circuit 706 is configured to receive a message from another communication device, the message comprising a specification of a range or ranges of subcarriers and a specification of a superframe or a plurality of superframes wherein the specified range or ranges of subcarriers may not be used during the specified superframe or the specified plurality of superframes.

In one embodiment, the message comprises the number or length of time intervals during which the frequency range may not be used for transmitting data. In one embodiment, each time interval is a superframe. For example, the message may comprise the number of superframes for which the frequency range may be tone-nulled for transmitting data. In one embodiment, the message may comprise the number of superframes during which the specified range or ranges of subcarriers may not be used for transmitting data.

In one embodiment, the message specifies the size of the frequency range. As an illustration, the message may specify how many frequency subcarriers are not to be used. In one embodiment, the message may specify the number of frequency subcarriers of each specified range of frequency subcarriers.

In one embodiment, the communication device 700 is a communication device according to ECMA standard.

In one embodiment, the communication device 700 is part of a communication system with a plurality of ad-hoc communication devices, wherein each communication device of the communication devices is not allowed to transmit data using the frequency range during the time interval. In one embodiment, the communication system may comprise a plurality of ad-hoc communication devices as shown in FIG. 2, and all the communication devices A 211 to H 218 are not allowed to transmit data using the frequency range, i.e. range or ranges of subcarriers, during the time interval, i.e. a superframe or a plurality of superframes.

In one embodiment, a method for controlling the usage of frequency ranges for data transmission, comprises: storing, in a memory of an ad-hoc communication device, a parameter specifying, a time interval and at least one frequency range, wherein the frequency range may not be used for transmitting data during the time interval; controlling a sending circuit of the communication device such that the frequency range is not used for transmitting data during the time interval; generating a message including a specification for the time interval and for the at least one frequency range or for a starting frequency of the at least one frequency range, wherein the frequency range may not be used for transmitting data during the time interval; and transmitting the message.

In one embodiment, a computer program product which, when executed by a computer, makes the computer perform a method for controlling the usage of frequency ranges for data transmission, comprising: storing, in a memory of an ad-hoc communication device, a parameter specifying a time interval and at least one frequency range or a starting frequency of at least one frequency range, wherein the frequency range may not be used for transmitting data during the time interval; controlling a sending circuit of the communication device such that the frequency range is not used for transmitting data during the time interval; generating a message including a specification for the time interval and for the at least one frequency range or for the starting frequency of the at least one frequency range, wherein the frequency range may not be used for transmitting data during the time interval; and transmitting the message.

In one embodiment, a method for operating an ad-hoc radio communication device in a devices' communication group is provided, the method comprising generating a tone nulling synchronization negotiation message including information about the frequencies corresponding to which the ad-hoc radio communication device will null tones; and transmitting the tone nulling synchronization negotiation message to at least one other ad-hoc radio communication device with which the ad-hoc radio communication device has an established communication connection in a current frequency channel.

In one embodiment, the tone nulling synchronization negotiation message further comprises a specification of at least one time interval during which the ad-hoc radio communication device will null tones corresponding to the frequencies.

In one embodiment, the tone nulling synchronization negotiation message further comprises a specification of a first tone or a first frequency from a set of tones or a set of frequencies according to which the ad-hoc radio communication device will null tones during the time interval.

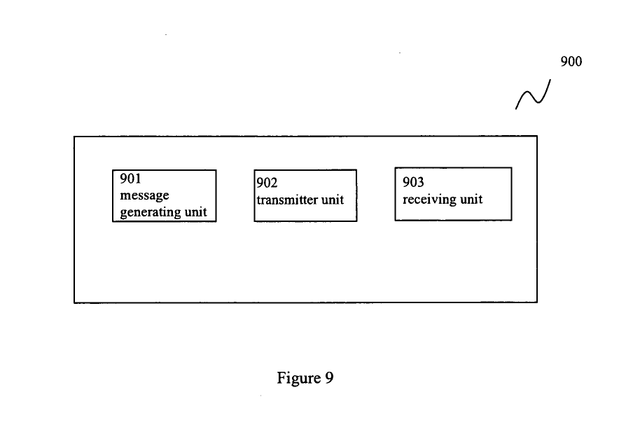

FIG. 9 shows an ad-hoc radio communication device 900 within a communication system for transmitting OFDM symbols according to one embodiment.

The ad-hoc radio communication device may comprise a message generating unit 901, a transmitter unit 902, and a receiver unit 903.

In one embodiment, the message generating unit 901 may be configured to generate a tone nulling synchronization negotiation message to inform other communication devices which tones or frequencies and for what duration the ad-hoc radio communication device will null the specified tones or frequencies, or to inform other communication devices the starting tone or frequency of a set of tones or frequencies and for what duration the ad-hoc radio communication device will null the tones or frequencies in the set of tones or frequencies.

In one embodiment, the transmitter unit 902 is configured to transmit the tone nulling synchronization negotiation message to at least one other ad-hoc radio communication device with which the ad-hoc radio communication device has an established communication connection in a current frequency channel.

In one embodiment, the receiver unit 903 is configured to receive messages from other communication devices within the ad-hoc radio communication devices' group.

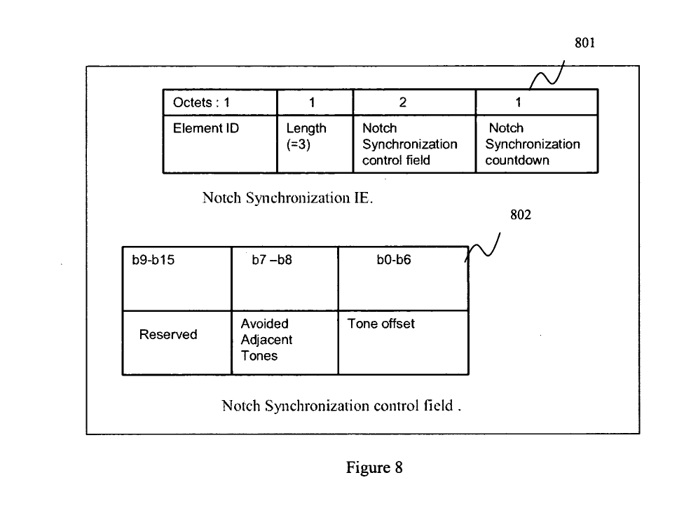

FIG. 8 shows the format of a proposed Notch Synchronization IE 801 and the Notch Synchronization control field 802 according to one embodiment.

As can be seen from the proposed Notch Synchronization IE 801, the octet “Notch Synchronization countdown” may be used to specify the length of the time interval (number of superframes) during which tone nulling is to be carried out. In one embodiment, bits b0-b6 in the Notch Synchronization control field 802 may specify a tone offset which is the first tone or first frequency in a set of tones or frequencies, wherein the set of tones corresponding to the first tone or the tone offset specified is to be nulled or not to be used during the time interval. In one embodiment, the bits b7 and b8 in the Notch Synchronization control field 802 may specify the number of tones adjacent to the set of tones on each side of the set of tones that will be nulled or not used during the time interval.

With the proposed IE, it is possible for the entering devices to know for how long the current set of tones be nulled before a new set of tones are started to be nulled.

In every superframe a fixed set of pSweptNotchWidth tones are nulled beginning with the Tone offset. In one embodiment, the value of the parameter pSweptNotchWidth may be 4 or 8 or 12, but is not limited thereto. In one embodiment, the set of tones to be nulled are specified by the number of tones to be nulled (pSweptNotchWidth) and a starting point which is the tone offset number which can be one of 0-127. In one embodiment, if the number of tones to be nulled (pSweptNotchWidth) is already coded in every device, then this information need not be propagated between devices using the proposed IE, but only the tone offset number is needed to be communicated. The Notch Synchronization countdown in 801 is decremented by one every superframe and re-initialized to pSweptNotchDuration once the count down counter reaches zero. In one embodiment, the value of pSweptNotchDuration may be 12 or 24 but is not limited thereto.

Once the countdown given in the Notch Synchronization IE is zero, the next set of pSweptNotchWidth tones starting from previous Tone offset plus pSweptNotchWidth modulo 127 numbered tone are nulled from next superframe.

In one embodiment, the Avoided Adjacent Tones field in 802 contains the number of tones adjacent to each side of pSweptNotchWidth nulled tones that are nulled by the transmitting device. In one embodiment, the Notch Synchronization IE is sent every superframe by every device and all devices ensure that same set of tones are indicated and nulled (Tone offsets to be the same). If the tone offsets are different in any superframe among the IEs received, all devices shall update their Tone offset field to the lowest value inferred from all the communication devices in the next superframe. In one embodiment, in the event that the countdown has reached zero for any device and if that device anticipates that all other communication devices are expected to null tones from a certain Tone offset in the next superframe given the above protocol, the device shall include that Tone offset in the Notch Synchronization IE in the next superframe. In one embodiment, each device shall also ensure that the same countdown value is included in the Notch Synchronization IEs in the current superframe by adjusting its countdown field according to the lowest countdown value as inferred from IEs received in the previous superframe (taking into account the decrementing of any countdown value by 1 every superframe) if the count down values are different.

In one embodiment, it is proposed that a channel operating at 2.4 GHz or 5 GHz be used as a control channel to facilitate notch synchronization among beacon groups that operate in different channels. A low cost, low complexity addition to the current ECMA specified PHY that is based on Quadrature Phase Shift Keying or QPSK (Single Carrier Modulation) is proposed to cater to control channel operation at 2.4 GHz or 5 GHz. The control information or frame transmitted by a device over the control channel may include operating channel number, a bitmap corresponding to the operating Time Frequency Code (TFC) as included in the ECMA specified PLCP header, highest occupied beacon slot in the beacon group of the device, BPST of the device with reference to the end of the preamble of transmitted control frame, and/or the notch synchronization IE.

In one embodiment, an active operating device in a beacon group when it is not transmitting shall always listen to the bandwidth corresponding to a control channel such as a 2.4 GHz channel or 5 GHz channel when a signal energy (pertaining to Single Carrier (SC) transmission) and/or preamble is detected. If an active operating device in a beacon group has detected a bit map corresponding to a TFC number different from the current operating TFC or a channel number different from the current operating channel number for a fixed number of consecutive superframes in received control frames in the control channel, it may be inferred that a simultaneously operating beacon group in another channel has been detected by the device.

In one embodiment, the suggested channel access scheme to access the control channel is Carrier Sense Multiple Access or CSMA (sensing may be based on preamble) with back off. Every device or every transmitting device (the device transmitting OFDM data or beacon) has to contend for the control channel to transmit one control channel frame. A device has to execute a random or fixed back off after transmitting the control channel frame before sensing the channel again for another control channel frame transmission. Subsequently, if channel is sensed busy (may be based on preamble detection), a random back off is invoked. In one embodiment, only transmitting device (the device transmitting OFDM data or beacon) may need to use the control channel.

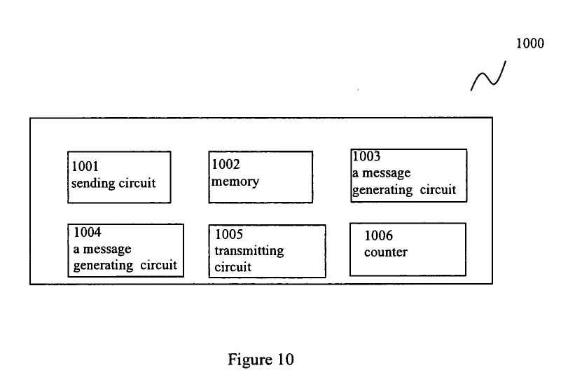

FIG. 10 shows an ad-hoc communication device 1000 according to one embodiment.

The ad-hoc communication device 1000 may comprise a sending circuit 1001, a memory 1002, a first message generating unit 1003, a second message generating unit 1004, and a transmitting circuit 1005.

In one embodiment, the sending circuit 1001 is configured to transmit data on a control channel operating at a frequency range differing from another frequency range or the frequency range at which another frequency channel operates; wherein the other frequency range or other frequency channel is used by the device to communicate with other ad-hoc communication devices in a communication group.

In one embodiment, the memory 1002 is configured to store a parameter specifying a time interval and at least one frequency range or a starting frequency of at least one frequency range, and specifying, that the at least one frequency range may not be used for transmitting data during the time interval using the other frequency range or the other frequency channel.

In one embodiment, the first message generating unit 1003 is configured to generate a message including a specification specifying a time interval and at least one frequency range or a starting frequency of at least one frequency range, and specifying that the frequency range may not be used for transmitting data during the time interval using the other frequency range or the other frequency channel.

In one embodiment, the second message generating unit 1004 is configured to generate a message including a specification of the other frequency range or the other frequency channel, the highest time slot occupied in a time period on the other frequency channel, and a time of reference for the device in the other frequency channel.

In one embodiment, the transmitting circuit 1005 is configured to transmit the messages generated by the first message generating unit and the second message generating unit.

In one embodiment, the control channel is a 2.4 GHz channel or a 5 GHz channel.

In one embodiment, the other frequency range is a band or band group. In one embodiment, the other operating channel is a Time Frequency Code (TFC). In one embodiment, the highest time slot occupied is a highest occupied beacon slot. In one embodiment, the time period is the beacon period of the device. In one embodiment, the time of reference is the Beacon Period Start Time of the device or time between the end of preamble of the message and the Beacon Period Start Time of the device in the next superframe. In one embodiment, the data is the data included in a frame. In one embodiment, the message corresponds to a control frame.

In one embodiment, the ad-hoc communication device 1000 is configured to use the control channel only while transmitting data in the other frequency channel.

In one embodiment, the ad-hoc communication device 1000 uses the control channel when the control channel is released from being used.

In one embodiment, the ad-hoc communication device 1000 further comprises a counter 1006 associated with the control channel, wherein upon the release of the control channel from being used, the counter 1006 starts being decremented from a predetermined value, wherein, when the counter reaches zero, the device starts to transmit a symbol or a frame using the control channel.

In one embodiment, the ad-hoc communication device 1000 is configured to determine that the control channel has been released from being used based on detecting an absence of a predetermined sequence transmitted via the control channel. In one embodiment, the predetermined sequence is a preamble.

In one embodiment, the ad-hoc communication device 1000 is configured to transmit Orthogonal Frequency Division Multiplexing symbols via the other frequency channel and Single Carrier modulated data or Quadrature Phase Shift Keying modulated data via the control channel.

It should be noted that although the illustration is made based on the ECMA standard, the embodiment of the invention is not limited to the ECMA standard, but can be extended to communication system that requires synchronization among communication devices within the communication system.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In this document, the following documents are cited:
[1] Standard ECMA-368, High Rate Ultra Wideband PHY and MAC Standard, December 2007
[2] WiMedia MAC Release 1.0, Distributed Medium Access Control (MAC) for Wireless Networks, December 2005, http://www.wimedia.org/en/index.asp
[3] A. Subramanian, X. Peng, and F. Chin, Schemes for achieving higher throughput in network of ECMA Specified devices, Submitted for provisional US patent.
[4] C. Razzell, Detect and avoid with a swept notch UWB transmitter, WiMedia Alliance Inc.
[5] A. Subramanian, X. Peng, and F. Chin, Guidelines for standardization of a DAA framework, Institute for Infocomm Research, Singapore.

1-66. (canceled)

67. A communication device comprising:
a receiving circuit configured to receive a message from another communication device;
a time base circuit providing a time base signal that specifies a plurality of time periods;
a determining circuit configured to determine, based on an expected reception time of the message and a reception time of the message, a parameter value characterizing a time base offset between the communication device and the other communication device;
an offset generating circuit configured to generate a time period offset value specifying a time offset from a point in time, the time period offset value corresponding to a number of time periods from the plurality of time periods, wherein the number of time periods is determined according to the parameter value;
wherein the time base signal is a periodic time base signal; and
wherein the parameter value also characterizes the difference of the periodicity of the time base signal and the periodicity of the time base signal of the other communication device.

68. The communication device according to claim 67, wherein the message is a message of a plurality of messages transmitted periodically.

69. The communication device according to claim 67, wherein the parameter value characterizes a difference between the time base signal and a time base signal of the other communication device.

70. The communication device according to claim 67, wherein, if the parameter specifies that the time base signal is ahead of the time base signal of the other communication device, the number of time periods for the time offset is determined to be lower than the number of time periods given by the time base signal.

71. The communication device according to claim 67, wherein the time base signal is a clock signal.

72. The communication device according to claim 71, wherein the clock signal is provided by a physical quartz crystal.

73. The communication device according to claim 71, wherein the communication device receives from the other communication device a periodic message being transmitted with reference to a transmission time point determined based on a time base signal of the other communication device.

74. The communication device according to claim 73, wherein the time point is the Beacon Period Start Time of the other communication device or the Beacon Period Start Time of the communication device.

75. The communication device according to claim 73, wherein the periodicity of the periodic message the communication device receives does not change for a fixed time period and the periodicity refers to a period length.

76. The communication device according to claim 75, wherein the periodic message is a beacon, the period length is a superframe duration of the other communication device in accordance with the time base signal of the other communication device, and the fixed time period is the duration of two superframes in accordance with the time base signal of the other communication device.

77. The communication device according to claim 75, wherein the communication device estimates the clock period or the time base signal of the other communication device with reference to the time base signal or the clock period of the communication device during the fixed time period.

78. The communication device according to claim 77, wherein the clock period C_{D} of the other communication device is estimated to be C_{D}=(Y′−Y)/(p+m(n₂−n₁)), wherein Y is the reception time of a beacon from the other communication device at superframe N; Y′ is the reception time of a beacon from the other communication device at superframe N+1; p is the number of clock periods during a superframe duration for the communication device; m is the number of clock periods during a beacon period for the communication device; n₂ is the beacon slot number of the beacon from the other communication device in superframe N+1; and n₁ is the beacon slot number of the beacon from the other communication device in superframe N.

79. The communication device according to claim 77 wherein the communication device assumes its clock period to be 1/528 microseconds, or 1/66 microseconds, or 1/F seconds, wherein F is the frequency of the physical clock crystal used by the communication device.

80. The communication device according to claim 75, wherein the communication device determines the Beacon Period Start Time of the other communication device to be B_{D}=Y−(n₁−1)C_{D}m=Y−(n₁−1)(Y′−Y)m/(p+m(n₂−n₁)), wherein Y is the reception time of a beacon from the other communication device at superframe N; Y′ is the reception time of a beacon from the other communication device at superframe N+1; p is the number of clock periods during a superframe duration for the communication device; m is the number of clock periods during a beacon period for the communication device; n₂ is the beacon slot number of the beacon from the other communication device in superframe N+1; and n₁ is the beacon slot number of the beacon from the other communication device in superframe N; C_{D} is the clock period of the other communication device with reference to the clock period of the communication device.

81. The communication device according to claim 75 wherein the communication device determines that the number of clock periods the other communication device counts in accordance with the time base signal of the other communication device during the period length of the periodic message is F times 0.065536 clock cycles wherein F is the frequency of the physical clock crystal used by the device.

82. The communication device according to claim 75 wherein the communication device determines the number of clock periods given by a physical clock of the communication device in accordance with the time base signal during the period length of the periodic message.

83. The communication device according to claim 75 wherein the communication device sets up a virtual clock cycle counter at the end of the fixed time period and initializes the virtual clock cycle counter to be zero at the end of the fixed time period.

84. The communication device according to claim 83, wherein the device updates the virtual clock cycle counter after it is initialized to zero such that the virtual clock cycle counter is obtained from the number of physical clock cycles given by a physical clock since the end of the fixed time period or since the initialization of the virtual clock cycle counter to zero by subtracting one clock cycle from the number of physical clock cycles every Floor[P/(P−Q)] or Round[P/(P−Q)] of physical clock cycles if P is greater than Q, wherein P is the number of clock cycles given by the physical clock of the communication device in accordance with the time base signal during the period length of the message, and wherein Q is the number of clock cycles given by the physical clock of the other communication device in accordance with the time base signal of the other communication device during the period length of the message.

85. The communication device according to claim 83, wherein the communication device sets its virtual clock to be the same as a physical clock of the communication device if P is less than or equal to Q, wherein P is the number of clock cycles given by the physical clock of the communication device in accordance with the time base signal during the period length of the message, and wherein Q is the number of clock cycles given by the physical clock of the other communication device in accordance with the time base signal of the other communication device during the period length of the message.

86. The communication device according to claim 75, wherein the device determines that its physical clock is slower than the physical clock of the other communication device if P is less than or equal to Q, wherein P is the number of clock cycles given by the physical clock of the communication device in accordance with the time base signal during the period length of the message, and wherein Q is the number of clock cycles given by the physical clock of the other communication device in accordance with the time base signal of the other communication device during the period length of the message.

87. The communication device according to claim 75, wherein the device determines that its physical clock is faster than the physical clock of the other communication device if P is greater than Q, wherein P is the number of clock cycles given by the physical clock of the communication device in accordance with the time base signal during the period length of the message, and wherein Q is the number of clock cycles given by the physical clock of the other communication device in accordance with the time base signal of the other communication device during the period length of the message.

88. The communication device according to claim 83, wherein the communication device resets its virtual clock counter to zero at the end of every superframe of the other communication device in accordance with the time base signal of the other communication device.

89. The communication device according to claim 86, wherein the device determines if it has the slowest physical clock in a communication system comprising the communication device and neighboring devices of the communication device.

90. The communication device according to claim 87, wherein the other communication device has the slowest physical clock of the communication devices in the communication system.

91. The communication device according to claim 71, wherein the time base signal of the other communication device is a clock signal and the parameter characterizes the clock drift between the clock signal and the clock signal of the other communication device.

92. The communication device according to claim 67, wherein the receiving circuit is configured to receive a first message and a second message and the determining circuit is configured to determine the parameter value, based on an expected reception time of the first message, an expected reception time of the second message, a reception time of the first message, and a reception time of the second message.

93. The communication device according to claim 67, wherein the time periods are regular time periods.

94. The communication device according to claim 67, wherein the time periods are clock cycles.

95. The communication device according to claim 67, wherein the offset generating circuit is configured to count a number of clock cycles having passed since the point in time.

96. The communication device according to claim 95, wherein the number of clock cycles is the number of clock cycles that have passed according to the time base signal, increased or decreased according to the parameter value.

97. The communication device according to claim 96, wherein the parameter value specifies the periodicity with which a clock cycle among the clock cycles indicated by the time base signal is not counted as clock cycle having passed since the point in time.

98. A method for generating a time indication comprising:
receiving a message from another communication device;
providing a time base signal that specifies a plurality of time periods;
determining, based on an expected reception time of the message and a reception time of the message, a parameter value characterizing a time base offset between the communication device and the other communication device;
generating a time period offset value specifying a time offset from a point in time, the time period offset value corresponding to a number of time periods from the plurality of time periods, wherein the number of time periods is determined according to the parameter value;
wherein the time base signal is a periodic time base signal; and
wherein the parameter value also characterizes the difference of the periodicity of the time base signal and the periodicity of the time base signal of the other communication device.

99. A computer program product which, when executed by a computer, makes the computer perform a method for generating a time indication comprising:
receiving a message from another communication device;
providing a time base signal that specifies a plurality of time periods;
determining, based on an expected reception time of the message and a reception time of the message, a parameter value characterizing a time base offset between the communication device and the other communication device;
generating a time period offset value specifying a time offset from a point in time, the time period offset value corresponding to a number of time periods from the plurality of time periods, wherein the number of time periods is determined according to the parameter value;
wherein the time base signal is a periodic time base signal; and
wherein the parameter value also characterizes the difference of the periodicity of the time base signal and the periodicity of the time base signal of the other communication device.

100. A method for operating an ad-hoc radio communication device in a devices' communication group, the method comprising:
generating a tone nulling synchronization negotiation message including information about the frequencies corresponding to which the ad-hoc radio communication device will null tones and including information about a specification of at least one time interval during which the ad-hoc radio communication device will null the frequencies or tones; and
transmitting the tone nulling synchronization negotiation message to at least one other ad-hoc radio communication device with which the ad-hoc radio communication device has an established communication connection in a current frequency channel;
wherein the tone nulling synchronization negotiation message further comprises a specification of a first tone or a first frequency from a set of tones or a set of frequencies according to which the ad-hoc radio communication device will null tones during the time interval.

101. An ad-hoc communication device comprising:
a sending circuit configured to transmit data on a control channel operating at a frequency range differing from another frequency range or the frequency range at which another frequency channel operates; wherein the other frequency range or other frequency channel is used by the device to communicate with other ad-hoc communication devices in a communication group;
a memory configured to store a parameter specifying, a time interval and at least one frequency range or a starting frequency of at least one frequency range, wherein the at least one frequency range may not be used for transmitting data during the time interval using the other frequency range or the other frequency channel;
a first message generating unit configured to generate a message including a specification specifying, a time interval and at least one frequency range or the starting frequency of at least one frequency range wherein the frequency range may not be used for transmitting data during the time interval using the other frequency range or the other frequency channel;
a second message generating unit configured to generate a message including a specification of the other frequency range or the other frequency channel, the highest time slot occupied in a time period on the other frequency channel, and a time of reference for the device in the other frequency channel;
a transmitting circuit configured to transmit the messages generated by the first message generating unit and the second message generating unit.

102. The ad-hoc communication device of claim 101, wherein the control channel is a 2.4 GHz channel or a 5 GHz channel.

103. The ad-hoc communication device of claim 101, wherein the other frequency range is a band or band group, the other operating channel is a Time Frequency Code (TFC), the highest time slot occupied is a highest occupied beacon slot, the time period is the beacon period of the device, the time of reference is the Beacon Period Start Time of the device or time between the end of preamble of the message and the Beacon Period Start Time of the device in the next superframe, the data is the data included in a frame, and the message corresponds to a control frame.
